(19) United States
(12) Patent Application Publication
(10) Pub. No.: US 2009/0008409 A1
(43) Pub. Date: Jan. 8, 2009

(54) Optical Filling Level Detection Device for Powdered Material

(75) Inventors: Ramon Eduard Verhoeven, Heerhugowaard (NL); Carlos Nicolaas Jozef Maria Koopman, Heerhugowaard (NL); Leonardus Cornelis Van Der Velden, Winkel (NL)

Correspondence Address: THE WEBB LAW FIRM, P.C., 700 KOPPERS BUILDING, 436 SEVENTH AVENUE, PITTSBURGH, PA, 15219, US

(73) Assignee: BRAVILOR HOLDING B.V., Heerhugowaard (NL)

(21) Appl. No.: 12/161,888

(22) PCT Filed: Jan. 26, 2007
(86) PCT No.: PCT/NL2007/050032

§ 371 Date: Jul. 23, 2008

(30) Foreign Application Priority Data
Jan. 26, 2006 (NL) 1031010

(51) Int. Cl. B67D 5/08

(52) U.S. Cl. 222/64

(57) ABSTRACT

The invention relates to a filling level detection device for powdered material. The filling level detection device has a storage unit and a sensor. The storage unit has a container provided with a discharge aperture for discharging metered quantities of powdered material. The sensor has a light source for transmitting a light beam, and a detection unit for detecting a light intensity. A wall of the container at least in one zone is at least partially transparent to light transmitted by the light source. In addition, the sensor is placed outside the container in such a way that the light source directs the light beam onto the zone in the wall of the container, and the detection unit intercepts light reflected by the powdered material and emerging through the zone in the wall of the container. The light source and the detection unit are placed in one horizontal plane.

The invention relates to a filling level detection device for powdered material, comprising:
a storage unit comprising a container provided with a discharge aperture for discharging metered quantities of powdered material;
a sensor comprising a light source for transmitting a light beam and a detection unit for detecting a light intensity;
   in which a wall of the container at least in one zone is at least partially transparent to light transmitted by the light source, and in which the sensor is placed outside the container in such a way that the light source directs the light beam onto the zone in the wall of the container and the detection unit intercepts light reflected by the powdered material and emerging through the zone in the wall of the container. Examples of powdered material comprise coffee, milk/creamer and sugar. With such a filling level detection device it can be determined whether there is still a sufficient quantity of powdered material in the container of the storage unit, without the quality of the powdered material being damaged by such detection. This stands to reason because with the sensor it is possible to determine whether there is sufficient powdered material present in the container without direct contact being made with the powdered material.

U.S. Pat. No. 6,234,603 discloses a system for detecting the presence of ink in an ink container (cartridge) and if ink is present, determining the ink level in said cartridge. In order to achieve this, the system comprises a sensor with a source, a detector and at least one reflective element. The source and the detector are either integral with a part of the wall or are loose elements placed one above the other. A disadvantage of this system is that through the positioning of source and detector relative to each other several possible ink levels are measured simultaneously.

The invention aims to provide a filling level detection device which can work more accurately. For this reason, the filling level detection device according to the invention is characterized in that the light source and the detection unit are placed in one horizontal plane. Such a mutual positioning of light source and detection unit is more or less perpendicular to the drop-direction of the powdered material. Exposure with the same light beam means that fewer possible levels of powdered material are exposed than would be the case with a vertical mutual positioning. As a result of this, in various situations there is less spread in the measurements by means of the detection unit when determining whether the powdered material is above or below one level. As a result, the sensor can work more accurately.

Preferably, the filling level detection device further comprises an indicating element for indicating when there is insufficient powdered material in the container of a storage unit, and the detection unit is arranged for transmitting a signal if the detected light intensity is lower than a predetermined limit value. In this way it is possible, without looking in the storage unit, to indicate already that there is insufficient powdered material present in the container of the storage unit. The signal can be an ‘empty’ signal which is transmitted to the detection element. However, it is also possible for the filling level detection device to further comprise a processor and for the signal to be a threshold signal which is transmitted to the processor if the detected light intensity is lower than a predetermined limit value. The processor is arranged for counting a predetermined number of portions of powdered material after receiving the threshold signal and to transmit an ‘empty’ signal to the indicating element after the predetermined number of portions of powdered material has been reached.

In an embodiment of the filling level detection device the transmitted light beam is parallel or divergent. In another embodiment of the filling level detection device the transmitted light beam converges in such a way that a focal point of the light beam lies outside the storage unit. Owing to the abovementioned feature of the light beam in these embodiments, the light falls upon a relatively large surface area with powdered material with the result that the filling level detection device can function even when the wall is soiled. The angle between the light beam and the wall preferably lies between 40 and 90 degrees. With such an angle there is less chance of an incorrect signal as a result of a soiled wall.

In all embodiments of the filling level detection device, the light source can be arranged for transmitting a pulsed light beam with a predetermined pulse frequency. The detection unit in such a case is arranged for detecting light intensity of light coming from the pulsed light beam. In such embodiments an unfavourable influence of ambient light on the functioning of the filling level detection device can be reduced by the fact that light coming from the light source of the filling level detection device is recognizable in “noise”.

In all embodiments the light source can be arranged for transmitting a light beam comprising a dominant wavelength in the infrared wavelength range. By making use of light with a dominant wavelength from this wavelength range, which extends from approximately 750 nm to 50 μm, it is possible to make use of standard polycarbonate containers. Furthermore, humans do not find such a wavelength disturbing, because the wavelength is outside the wavelength range which is visible for humans.

The invention further relates to a beverage-dispensing device for dispensing beverages based on powdered material, comprising a liquid-dispensing device for dispensing liquid, a storage unit for dispensing powdered material and a mixing space for mixing the liquid as dispensed by the liquid-dispensing device and the powdered material as dispensed by the storage unit, the beverage-dispensing device comprising a filling level detection device according to an embodiment of the invention. The wall of the beverage-dispensing device is provided with a closable aperture, and the sensor of the filling level detection device is mounted on the closable aperture by means of a fixing structure. In that case the sensor is not in the way during maintenance, and this means that simple fixing is possible at a suitable location.

Finally, the invention relates to a method for detecting a filling level in a storage unit comprising a container for powdered material by means of a sensor placed outside said container, which sensor is provided with a light source and a detection unit, and also an indicating unit connected to the sensor, in which a wall of the container at least in one zone is at least partially transparent to light transmitted by the light source, the method comprising:
transmitting a light beam by means of the light source in such a way that the light beam is directed at the transparent zone in the wall of the container;
detecting by means of the detection unit a light intensity of light coming from the light beam, which light is reflected from the powdered material in the container and emerges through the zone in the wall of the container;
transmission of an ‘empty’ signal by the detection unit to the indicating unit if the detected light intensity is lower than a predetermined limit value.

However, it is also possible, however, for the signal transmitted by the detection unit to be a threshold signal that is sent to a processor. In this last case the method comprises a system in which the processor further counts a number of portions of powdered material drawn from the container until a predetermined number is reached and the processor transmits an ‘empty’ signal to the indicating unit. This last method is in particular suitable for use if the level of powdered material in the storage unit is position-dependent.

The light beam transmitted by means of the light source can be a pulsed light beam with a predetermined pulse frequency. In that case the detection of the light intensity is based on light coming from the pulsed light beam. Making use of such a pulsed light beam means that an unfavourable influence of ambient light on the method can be reduced by the fact that light coming from the light source of the filling level detection device is recognizable in “noise”.

The invention will be explained in more detail below by way of example with reference to the following figures. The figures are not intended to limit the scope of the invention, but only to illustrate the invention.

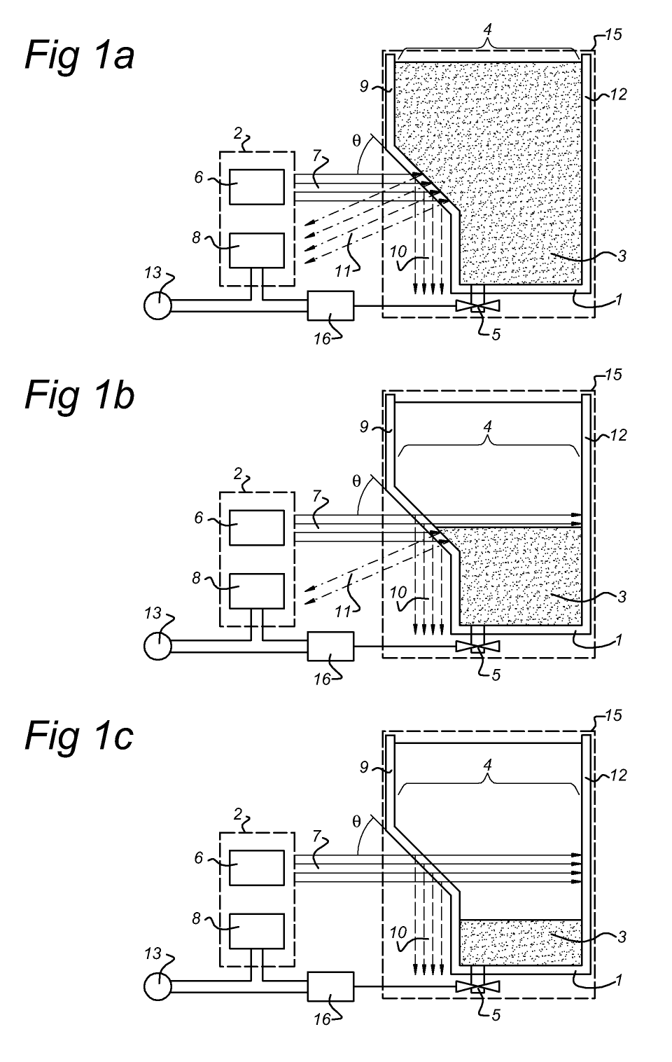

FIGS. 1a-1c schematically show an embodiment of a filling level detection device for powdered material according to the invention;

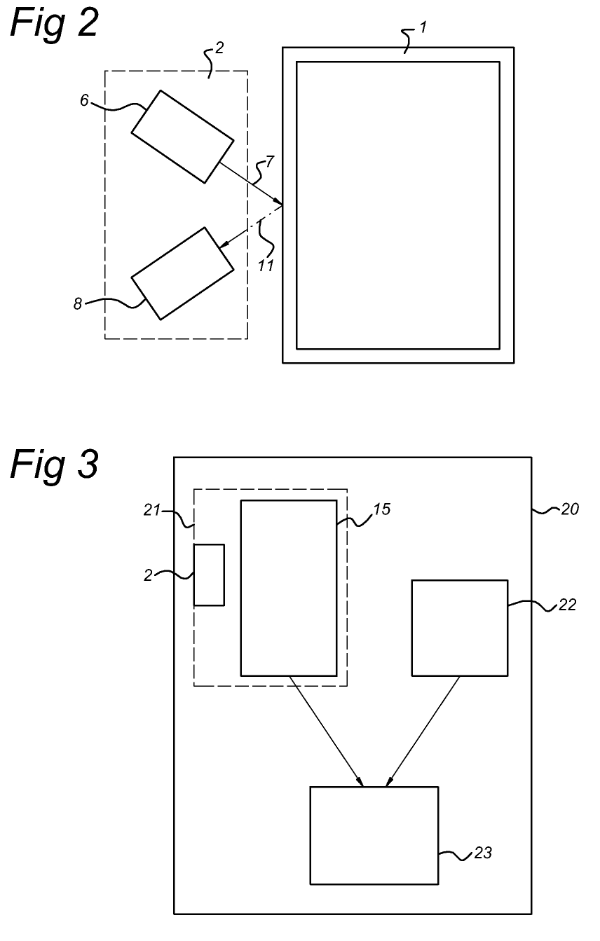

FIG. 2 schematically shows an embodiment of a sensor for use in a filling level detection device for powdered material according to the invention;

FIG. 3 schematically shows a beverage-dispensing device provided with a filling level detection device for powdered material according to an embodiment of the invention;

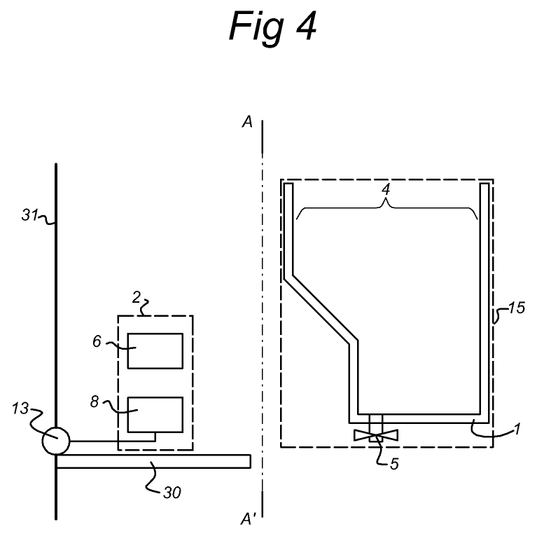

FIG. 4 schematically shows an embodiment of a filling level detection device for powdered material according to the invention which can be accommodated in a beverage-dispensing device of the type shown in FIG. 3.

FIGS. 1a-1c schematically show an embodiment of a filling level detection device for powdered material. The filling level detection device comprises a storage unit 15 and a sensor 2. The storage unit 15 further comprises a container 1, which in FIGS. 1a-1c is filled fill, half-full and insufficiently full, respectively, with powdered material 3. The container 1 is provided with a supply aperture 4 for supplying powdered material 3 and a discharge aperture 5 which is arranged for discharging powdered material 3 in metered quantities. In other words, the container 1 of the storage unit can be filled with powdered material 3 via the supply aperture 4, and the container 1 can be emptied via discharge aperture 5. It is, however, also possible, for example, for the storage unit to be filled via the discharge aperture 5. In such an embodiment, a separate supply aperture 4 is not present.

The sensor 2 comprises a light source 6 for transmitting a light beam with light rays 7, and a detection unit 8 for detecting a light intensity. The sensor 2 is placed outside the container 1 in such a way that the light intensity of a reflection from the powdered material 3 of the light beam 7 transmitted through a wall 9 of the container 1 of the storage unit 15 is at least partially detectable by means of the detection unit 8. The light source 6 is arranged for this in such a way that the light beam 7 is directed at a zone of the wall 9 which is at least partially transparent to the light transmitted by the light source 6. For this purpose, the detection unit 8 is positioned in such a way that it is capable of intercepting light coming from the light beam 7 which is reflected from the powdered material 3 and emerges through the at least partially transparent zone in the wall 9. In FIGS. 1a-1c, the entire wall 9 is at least partially transparent to the light transmitted by the light source 6. It is, however, also possible for only a limited part, i.e. a zone, of the wall 9 to be at least partially transparent to this light.

In FIG. 1a a large portion of the light beam 7 transmitted by the light source 6 falls through the wall 9 of the container 1 of the storage unit 15 upon the powdered material 3 present in said storage unit. A small portion of the light beam 7 will be reflected from the wall 9 or will be absorbed by the wall 9. Light rays reflected from the wall 9 are indicated by dashed arrows 10 in FIGS. 1a-1c. The light beam 7, as shown in FIGS. 1a-1c, preferably falls at an angle θ upon the wall 9 of the container 1 of the storage unit 15, so that virtually none of the reflected light rays are detected by the detection unit 8. However, as the person skilled in the art knows, it must be ensured here that the angle is not greater than a so-called limit angle, because in that case the light beam 7 will be reflected in its entirety. It has become clear from experiments that the angle θ between the light beam and the wall 9 of the container 1 of the storage unit 15 preferably lies between 40 and 90 degrees.

A large part of the light beam 7 will be reflected in many directions by the powdered material 3, of which a relatively large part through the wall 9 in the direction of the detection unit 8. Light beams reflected from the powdered material 3 in the direction of the detection unit 8 are indicated by dashed arrows 11 in FIGS. 1a-1b. The detection unit 8 then detects the light intensity of the light rays 11 reflected from the powdered material 3.

In FIG. 1b, the container 1 is only half full of powdered material 3. A part of the light beam 7 entering the container 1 through the wall 9 will leave the container 1 again on the other side through an opposite wall 12. As a result of this, the light intensity which is detected by the detection unit 8 will be lower in this case than the light intensity detected in the situation shown in FIG. 1a.

In FIG. 1c, the container 1 is virtually empty, in other words there is little powdered material 3 present. Virtually the entire part of the light beam 7 entering the container 1 through the wall 9 leaves the container 1 through the opposite wall 12. Only a small part will be reflected (not shown) from the opposite wall 12 or absorbed by said wall. The light intensity detected by the detection unit 8 will therefore be minimal.

By comparison with a predetermined limit value for the detected light intensity, it can be determined whether there is sufficient powdered material 3 present in the container 1. This limit value can, for example, correspond to a light intensity which is measured in the situation shown in FIG. 1b. If the detected light intensity is higher than the limit value, there is sufficient powdered material 3 present in the container 1. If, on the other hand, the detected light intensity is lower, there is insufficient powdered material 3, and it is desirable to replenish the contents of the container 1 in the storage device.

If there is insufficient powdered material 3 present in the container 1 of the storage device, i.e. in the event of the detected light intensity being lower than the predetermined limit value, the detection unit 8 can be arranged for transmitting an ‘empty’ signal. Such an ‘empty’ signal can be sent to an indicating element 13, for example an indicator light. By means of such an indicating element 13, with a suitable fastening known to the person skilled in the art, it is possible to indicate already that insufficient powdered material 3 is present in the container 1 of the storage unit 15 without opening a beverage-dispensing device in which the filling level detection device is accommodated.

Because the light beam 7 is reflected in all directions by the powdered material 3, the reliability of the sensor 2 can be increased by exposing a relatively large surface area of the container containing the powdered material 3. This can be achieved by arranging the light source 6 in such a way that the light beam 7 is transmitted so as to be either parallel or divergent or convergent, in the last-mentioned case the focal point of the light beam 7 lying outside the storage unit 15.

It is possible that the powdered material 3 soils the container 1. If the inside of the container is soiled, for example with a very fine powder coming from the powdered material 3, then, even if a relatively large surface area is exposed, a relatively large part of the light beam 7 will still be stopped by the thin layer of powder, either by undesirable reflection or by absorption. In that case the light intensity detected by the detection unit 8 will also be less than if ample powdered material 3 were present at the position of the incident light beam 7. The exposure of the container 1 with a light beam 7 at an angle, as shown in FIGS. 1a-1c, could even worsen the negative effect that such a soiling layer has on the reliability of the detection. In the worst-case scenario, the detection unit will in that case transmit a signal that there is sufficient powdered material 3 present in the container 1, while that is not the case.

In order to minimize the negative effect of a soiling layer on the reliability of the detection, it is possible to optimize the mutual position and/or orientation of the various elements of the filling level detection device. Parameters which can play a role in this optimization comprise angle θ, position of the detection unit 8 relative to the wall 9 (for example whether said detection unit is situated on a downwardly sloping part of the wall or on a “vertical” part of the wall), size of the surface to be exposed, distance of the light source 6 from the wall 9, a minimum detection level and also a limit value as regards intensity for the reflected light, etc.

Inter alia, as a result of the position of discharge aperture 5 and, if present, of supply aperture 4, the height of the powdered material 3 on one side of the container 1 can differ considerably from the height at another side of the container 1. It has become clear from experiments that there is a certain predictability in the height variation. In order to accommodate a position-dependent fall in the quantity of powdered material 3 in the container 1, an established fixed pattern can be used. The detection unit 8 is then positioned at such a point that a signal is transmitted when a limited predetermined known number of portions of powdered material 3 can still be drawn, for example through the discharge aperture 5. The signal can be an ‘empty’ signal, which again can be sent to an indicating element 13, for example an indicator light. The signal can, however, also be a threshold signal which is sent to a processor 16 arranged for counting portions of powdered material 3, for example in the form of an electronic counter. The processor 16 then counts the number of portions of powdered material 3 drawn after receipt of the threshold signal. When the processor 16 reaches the limited predetermined known number of portions, the processor 16 will transmit an ‘empty’ signal. The ‘empty’ signal can again be sent to an indicating element 13, such as an indicator light.

The light source 6 can be a single light source, for example a Light Emitting Diode (LED). It is, however, also possible to use more than one light source, in which case it is possible for each light source to be arranged for transmitting light of a different wavelength. The wavelengths transmitted by the light source can lie in the infrared wavelength range. This range here means the range comprising wavelengths between 750 nm and 50 μm, in which, in this application, in particular wavelengths between 800 and 1000 nm are suitable. Presently, common light sources 6 comprise, inter alia, light sources which are arranged for transmitting light with a wavelength of 880 nm or 940 nm. With such wavelengths it is possible to expose a container 1 made of polycarbonate, which is a common material for containers for storage of, for example, coffee in coffee machines. Furthermore, light with wavelengths from this wavelength range is not found to be disturbing, because they lie outside the wavelength range that is visible for humans. In some embodiments of the invention it is, however, also possible to use light sources 6 which transmit light with a wavelength lying in the wavelength range that is visible for humans, i.e. 450-700 nm.

The detection unit 8 can be a single component, for example a phototransistor or a photodiode. The limit value in this case can be determined by the break-even point of the phototransistor or photodiode concerned. It is, however, also possible to use a more complex detection unit 8, or a plurality of detection units 8. In these cases the storage unit can further comprise a processor, which determines, on the basis of the by the detection unit or plurality of detection units, whether there is sufficient powdered material 3 present in the container 1 of the storage unit. In this case the limit value can be stored in a memory linked to the processor, as is known to the person skilled in the art.

In order to prevent light from the environment from adversely affecting the functioning of the sensor 2, which can lead to errors in the detection, the light can be transmitted by the light source 6 in pulses at an arbitrary but known frequency. The frequency is then a different frequency than the frequency of any pulsating light source in the environment. In this way ordinary light sources supplied from the mains can radiate in pulses at a frequency of 100 or 120 Hz, said frequency being dependent upon the mains frequency, i.e. 100 Hz in the case of a 50 Hz mains frequency as is usual in Europe, and 120 Hz in the case of a 60 Hz mains frequency, which is the normal mains frequency in the United States. The sensor 2 in this case can be arranged in such a way that an ‘empty’ signal is based only on light which is detected by the detection unit 8 at a pulse frequency corresponding to that of the light source 6.

For the sake of clarity, the light source 6 and detection unit 8 in sensor 2 are positioned one above the other in FIGS. 1a-1c. It must be understood that it is also possible to position these elements relative to each other in another way, for example beside each other in a horizontal plane, as shown in FIG. 2. The term horizontal here means a direction which is at right angles to the direction in which gravity acts upon the powdered material 3, the so-called vertical direction. In many cases powdered material 3 will be drawn from the container 1 through the discharge aperture 5 in the vertical direction.

With a sensor of the type shown in FIG. 2 fewer possible levels of powdered material 3 are exposed, with the result that in various situations there is less spread when a level is detected by means of the detection unit 8. As a result of this, the sensor 2 can function more accurately.

FIG. 3 schematically shows a beverage-dispensing device 20 provided with an embodiment of a filling level detection device. The beverage-dispensing device 20 is suitable for dispensing beverages based on a mixture of liquid and powdered material. The beverage-dispensing device 20 comprises a storage unit 15 for powdered material and a liquid-dispensing device 22. The storage device 15 together with a sensor 2 is enclosed by a filling level detection device 21, which is shown only schematically here by a dashed line. The sensor 2 and the storage unit 15 can be in the form shown in the filling level detection device 21 shown in FIGS. 1a-1c.

In order to be able to dispense the required beverage, both a discharge unit of the liquid-dispensing device 22 and a discharge unit of the storage unit 15 are in communication with a mixing space 23. The discharge unit of the storage unit 15 can correspond to the discharge unit 5 shown in the embodiments of the filling level detection devices of FIGS. 1a-1c and FIG. 4. In the mixing space 23, the desired beverage can be obtained by mixing liquid and powdered material, after which dispensing can take place.

FIG. 4 schematically shows an embodiment of a filling level detection device for powdered material which can be accommodated in a beverage-dispensing device like the one shown in FIG. 3. The filling level detection device again comprises a storage unit 15 with a container 1 and a sensor 2. The container 1 of the storage unit 15 is to be filled. The sensor 2 is fixed by means of a fixing structure 30 on a closable opening in a wall of the beverage-dispensing device, for example a door 31. It is, however, also possible to fix the sensor 2 on another wall of the beverage-dispensing device by means of a fixing structure 30. In FIG. 4 the parts to the left of line A-A′ will be swung away from the parts to the right of this line, i.e. the container 1, when the door 31 is opened.

The fixing structure 30 is fitted in such a way that, if the door 31 is closed, the sensor 2 is positioned at a suitable distance and in a correct position relative to a wall 9 of the container 1 of the storage unit 15. When the door is opened, which can be necessary in order to fill the container 1 of the storage unit 15 with powdered material 3 by way of the supply aperture 4, or in order to carry out maintenance work on various parts inside the beverage-dispensing device, the sensor 2 is swung away together with the door 31. The fitting and positioning of the sensor 2 shown ensure that the sensor 2 is placed in the correct position, while said sensor is not in the way during maintenance or filling work. The sensor 2 therefore does not have to be removed and replaced in the correct position. The latter action in particular requires a great deal of precision. Furthermore, such an action may be forgotten. The method of fixing shown also reduces the chance of damage to or soiling of the sensor 2.

It must be understood that the terms “higher than” and “lower than” a limit value, as used in this description, correspond to a detected light intensity respectively higher than and lower than the light intensity incident upon the detection unit 8 compared with the light intensity incident upon the detection unit 8 in the case of the limit value. If the limit value is not expressed in light intensity, it is therefore possible that, where a value is higher than the limit value, an ‘empty’ signal may be transmitted by the detection unit 8. The ‘empty’ signal is therefore transmitted if the detected value has exceeded the limit value.

The above description merely describes a number of possible embodiments of the present invention. It is easy to see that many alternative embodiments of the invention can be conceived, all of which fall under the scope of the invention, which is determined by the following claims.

1-13. (canceled)

14: A beverage-dispensing device for dispensing beverages based on powdered material, comprising:
a liquid-dispensing device for dispensing liquid;
a storage unit for dispensing powdered material, the storage unit comprising a container provided with a discharge aperture for discharging metered quantities of powdered material;
a mixing space for mixing the liquid as dispensed by the liquid-dispensing device and the powdered material as dispensed by the storage unit; and
a filling level detection device for detecting a filling level of the storage unit, the filling level detection device comprising a sensor, the sensor comprising a light source for transmitting a light beam, and a detection unit for detecting a light intensity;
wherein a wall of the container at least in one zone is at least partially transparent to light transmitted by the light source, and
wherein the sensor is placed outside the container in such a way that the light source directs the light beam onto the zone in the wall of the container and the detection unit intercepts light reflected by the powdered material and emerging through the zone in the wall of the container, and a wall of the beverage-dispensing device is provided with a closable aperture, and the sensor of the filling level detection device is mounted on the closable aperture by means of a fixing structure.

15: The beverage-dispensing device according to claim 14, wherein the light source and the detection unit of the sensor are placed in one horizontal plane.

16: The beverage-dispensing device according to claim 14, wherein the filling level detection device furthermore comprises an indicating element for indicating when there is insufficient powdered material in the container of the storage unit, and in which the detection unit is arranged for transmitting a signal if the detected light intensity has exceeded a predetermined limit value.

17: The beverage-dispensing device according to claim 16, wherein the transmitted signal is an ‘empty’ signal which is transmitted to the indicating unit.

18: The beverage-dispensing device according to claim 16, wherein the filling level detection device furthermore comprises a processor, in which the signal transmitted is a threshold signal which is transmitted to the processor, and in which the processor is arranged for counting a predetermined number of portions of powdered material after receiving the threshold signal and to transmit an ‘empty’ signal to the indicating element after the predetermined number of portions of powdered material has been reached.

19: The beverage-dispensing device according to claim 14, wherein the transmitted light beam is parallel or divergent.

20: The beverage-dispensing device according to claim 14, wherein the transmitted light beam is convergent in such a way that a focal point of the light beam lies outside the storage unit.

21: The beverage-dispensing device according to claim 19, wherein a limit angle between the light beam and the wall is between 40 and 90 degrees.

22: The beverage-dispensing device according to claim 20, wherein a limit angle between the light beam and the wall is between 40 and 90 degrees.

23: The beverage-dispensing device according to claim 14, wherein the light source is arranged for transmitting a pulsed light beam of a predetermined pulse frequency, and the detection unit is arranged for detecting light intensity coming from the pulsed light beam.

24: The beverage-dispensing device according to claim 14, wherein the light source is arranged for transmitting a light beam comprising a dominant wavelength in the infrared wavelength range.
